(19) United States
(12) Patent Application Publication
(10) Pub. No.: US 2026/0028876 A1
(43) Pub. Date: Jan. 29, 2026

(54) ADJUSTABLE STRUCTURAL SUPPORT SYSTEM FOR OVERHEAD GARAGE DOOR

(71) Applicant: 218 LLC, Duluth, MN (US)

(72) Inventor: Kyle Bruckelmyer, Knife River, MN (US)

(21) Appl. No.: 19/274,787

(22) Filed: Jul. 21, 2025

Related U.S. Application Data
(60) Provisional application No. 63/674,894, filed on Jul. 24, 2024.

(51) Int. Cl. E06B 7/28

(52) U.S. Cl. CPC E06B 7/28

(57) ABSTRACT

A structural support system for an overhead door panel assembly includes an adjustment mechanism. A flexible strap of the adjustment mechanism includes opposing end regions attached at respective perimeter side regions of the door panel and a central region extending along the side of the door panel between the perimeter side regions. A mounting structure of the adjustment mechanism is disposed at the side of the door panel and between the central region of the flexible strap and the side of the door panel. A shaft of the adjustment mechanism extends from the mounting structure and through an aperture formed through the central region of the flexible strap. An adjustable portion of the adjustment mechanism engages the central region of the flexible strap near the aperture and is movable along the shaft to adjust spacing between the central region of the flexible strap and the side of the door panel.

### CROSS REFERENCE TO RELATED APPLICATION

The present application claims the filing benefits of U.S. provisional application Ser. No. 63/674,894, filed Jul. 24, 2024, which is hereby incorporated herein by reference in its entirety.

### FIELD OF THE INVENTION

The present disclosure relates generally to the field of both residential and commercial overhead garage doors.

### BACKGROUND OF THE INVENTION

It is generally known within the building, architectural and construction industries to incorporate and provide multi-panel overhead doors to the residential garage and commercial building industries. For example, a very common type of overhead garage door involves a series of generally rectangular and horizontally oriented door panels connected together by hinges such that the door can be both raised and lowered to alternately expose or open and again cover or close and secure a door opening to provide protection from the outside elements, as well as provide privacy and security. These types of overhead garage doors commonly include sets of wheels or rollers attached to the lateral sides of the respective movable door panels. The wheels or rollers generally provide support and location control for each of the door panels as the wheels themselves are generally supported and guided within sets of both vertical and horizontal tracks. Typically, sets of door tracks are attached and secured to and supported at the interior wall structure of the building adjacent to the right and left sides and top of the structural framework of the door opening.

This particular style of overhead garage door is popular from the design standpoint in that it provides efficient use of space and relative ease of operation including minimal and efficient panel movement and swing clearances. The basic overhead roll-up design further offers resulting mechanical safety advantages when the door is rolled or moved vertically upward and to the open position where the door assembly is efficiently and effectively temporarily stored or parked overhead and out of the way from the doorway access opening. The operating location, mechanical movement and closed position of these types of overhead garage doors is largely determined by the respective right and left side door tracks, door panel track wheels and their points of attachment to the wall or door frame. The practical result is typically and often a compromise between the required dimensional operating clearances of the door assembly, and the effective closing and sealing of the door panels to the corresponding structural opening. Various dimensional clearance distances between the door tracks, wheels, rollers, movable panels and the door frame are required to promote free engagement and movement within their desired ranges of motion and operation, and yet still provide reasonably effective degrees of sealing of the door panels to the corresponding structural opening for preferably ideal environmental weather tightness and structural integrity whenever the garage door is closed.

### SUMMARY OF THE INVENTION

The present disclosure provides a structural support system for an overhead door panel assembly. The structural support system includes an adjustment mechanism and a flexible strap. The adjustment mechanism includes a mounting structure configured to mount the structural support system at a side of a door panel of the overhead door panel assembly. A shaft extends from the mounting structure. An adjustable portion is selectively movable along the shaft. The flexible strap includes opposing end regions and a central region between the opposing end regions. With the structural support system mounted at the side of the door panel of the overhead door panel assembly, (i) the opposing end regions of the flexible strap are attached at respective perimeter side regions of the door panel and (ii) the central region of the flexible strap extends along the side of the door panel between the perimeter side regions. Moreover, the mounting structure is disposed at the side of the door panel and between the central region of the flexible strap and the side of the door panel. The shaft extends from the mounting structure and through an aperture formed through the central region of the flexible strap. The adjustable portion engages the central region of the flexible strap near the aperture and is movable along the shaft to adjust spacing between the central region of the flexible strap and the side of the door panel. With the structural support system mounted at the side of the door panel of the overhead door panel assembly, and with the central region of the flexible strap spaced from the side of the door panel, the flexible strap applies a biasing force at the door panel in a direction parallel to a longitudinal axis of the shaft. For example, with the flexible strap forming a convex shape relative to the side of the door panel, the biasing force is toward the side of the door panel. With the flexible strap forming a concave shape relative to the side of the door panel, the biasing force is away from the side of the door panel. Thus, the structural support system may be adjusted to urge or bias the door panel of the overhead door panel assembly toward a flattened shape, such as to reduce or at least partially counteract thermal bowing.

These and other objects, advantages, purposes and features of the present disclosure will become apparent upon review of the following specification and examples in conjunction with the drawings.

### BRIEF DESCRIPTION OF THE DRAWINGS

FIG. 1 is a perspective view of a door panel of an overhead door panel assembly with an adjustable structural support system disposed at an interior side of the door panel;

FIG. 2 is a front plan view of the structural support system;

FIG. 2A is an enlarged view of a portion of the structural support system;

FIG. 3 is a side plan view of the structural support system, with a strap flexed to a concave shape relative to a mounting bracket of the structural support system and the door panel; and

FIG. 3A is another enlarged view of a portion of the structural support system.

### DESCRIPTION OF THE PREFERRED EMBODIMENTS

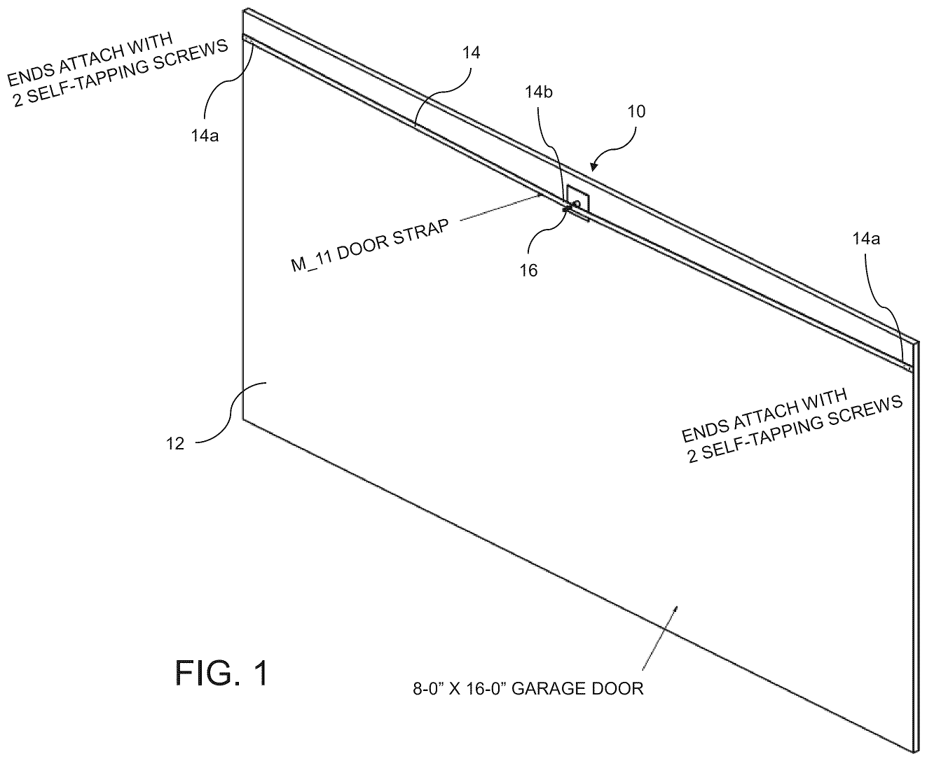

Referring now to the drawings and the illustrative examples depicted therein, an adjustable structural support system 10 for an overhead door panel assembly, such as a garage door assembly, is configured to attach to one or more door panels 12 of the overhead door panel assembly and the system 10 may be adjustable to correct or reduce or eliminate or resist bowing or buckling of the door panel 12 (FIG. 1). That is, the overhead door panel assembly includes one or more door panels or door panel sections 12 configured to be moved between a closed position, where the one or more door panels 12 close over or cover an opening in a building (e.g., a garage), and an opened position, where the one or more door panels 12 move away from the opening to provide access to the building. When the overhead door panel assembly is in the closed position, the one or more door panels 12 may engage a seal or gasket disposed around the opening in the building to preclude moisture and debris from entering the building and to thermally insulate the building from the environment. When there are temperature differences between the outside environment and the interior of the building (e.g., during winter when the environment may be cold and the interior of the building is heated or during summer when the environment may be hot and the interior of the building is cooled), one or more of the door panels 12 may experience thermal bowing. In other words, due to temperature differences between an exterior side of the door panel 12 and the interior side of the door panel 12, the sides of the door panel 12 (which may comprise steel, aluminum, vinyl, wood, or any suitable material) may experience different degrees of thermal expansion or contraction and thus flex or bend. This may cause a convex side of the door panel 12 to face the side experiencing the warmer temperature. This may reduce the integrity of the seal between the door panel and the building and/or cause permanent structural damage to the door panel.

The structural support system 10 includes a strap or bar 14 that is attached at opposing end regions 14a to the door panel 12 and an adjustment mechanism 16 attached to a central region of the door panel 12 and a central region 14b of the strap 14 between the opposing end regions 14a. As shown in FIG. 1, the strap 14 extends horizontally along the inner side of the door panel 12 with the adjustment mechanism 16 attached to a central region of the door panel and the central region 14b of the strap 14. As discussed further below, the adjustment mechanism 16 may adjust a distance between the central region 14b of the strap 14 and the central region of the door panel 12 to apply pressure to the door panel 12 via the adjustment mechanism 16 and reduce or eliminate bowing of the door panel 12.

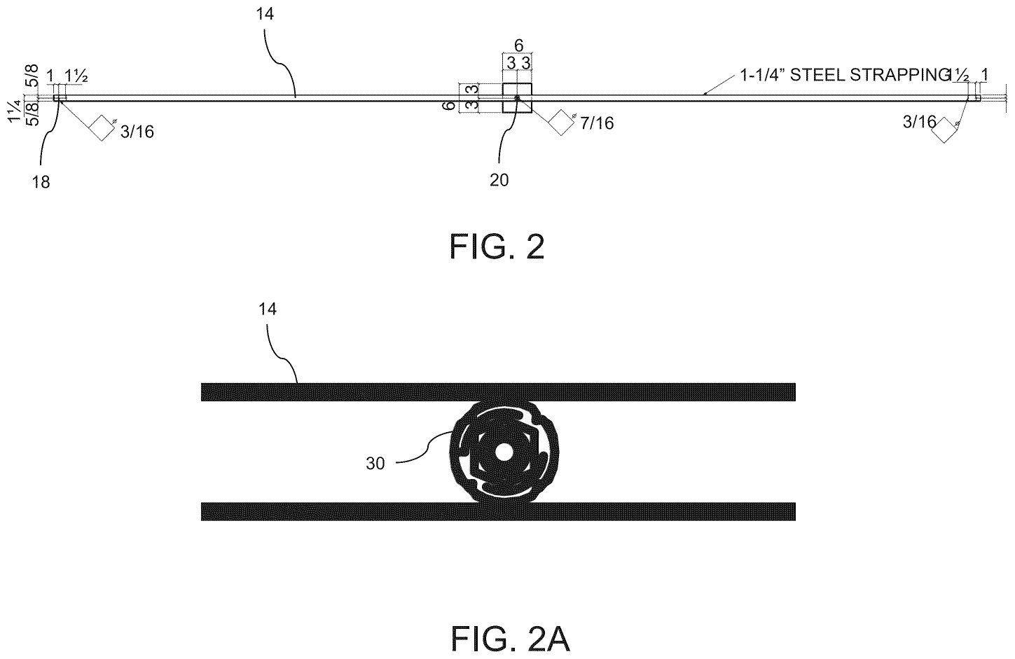

Each of the opposing end regions 14a of the strap 14 is attached to the interior side of the door panel 12 so that the end region 14a is engaging or disposed against or near the interior side of the door panel 12. In the illustrated example of FIGS. 1-3A, the end regions 14a of the strap 14 are attached to the door panel 12 via threaded fasteners, such as self-tapping screws, extending through respective openings 18 formed through the strap 14 and engaging the door panel 12. Each end region 14a of the strap 14 may include any suitable number of openings 18 configured to receive respective fasteners. As shown in FIG. 2, each end region 14a includes two openings 18 spaced from one another and aligned with one another along a longitudinal axis of the strap 14. Optionally, other suitable fasteners may be used to attach the opposing ends 14a of the strap 14 at the door panel 12, such as adhesive, epoxy, threaded bolts, and the like.

A central opening 20 is formed through the central region 14b of the strap 14 and configured to receive a portion of the adjustment mechanism 16. In the illustrated example, the adjustment mechanism 16 includes a mounting bracket 22 that attaches to the interior side of the door panel 12 (e.g., via adhesive, epoxy, threaded fasteners and the like). A pipe or receiver or spacer 24 extends from and/or is integrally formed with the mounting bracket 22 and a threaded shaft 26 extends from the receiver 24 and through the central opening 20 of the strap 14. Threaded receivers or nuts or holders 28 are received along the threaded shaft 26 at opposing sides of the strap 14 so that the position of the nuts 28 along the shaft 26 may be adjusted to set a distance of the central region 14b of the strap 14 from the mounting bracket 22 and the interior side of the door panel 12. The receiver 24 may maintain at least a threshold amount of space between the strap 14 and the interior side of the door panel 12. A flange or outer nut 30 may be disposed at an end of the threaded shaft 26 opposite the mounting bracket 22 to prevent the strap 14 from pulling off the threaded shaft 26.

That is, the central opening 20 of the strap 14 may be sized to allow the threaded shaft 26 to move freely through the opening 20 and restrict or prevent the nuts 28 from passing through the opening 20. Thus, the position of the central portion 14b of the strap 14 along the threaded shaft 26 relative to the door panel 12 may be adjusted by adjusting the position of the nuts 28 along the threaded shaft 26. Because the strap 14 comprises a flexible material (like a flexible metallic material like 1.25 inch steel strapping), the strap 14 applies a biasing force through the nuts 28 and threaded shaft 26 to the door panel 12 based on the position of the strap 14 along the threaded shaft 26.

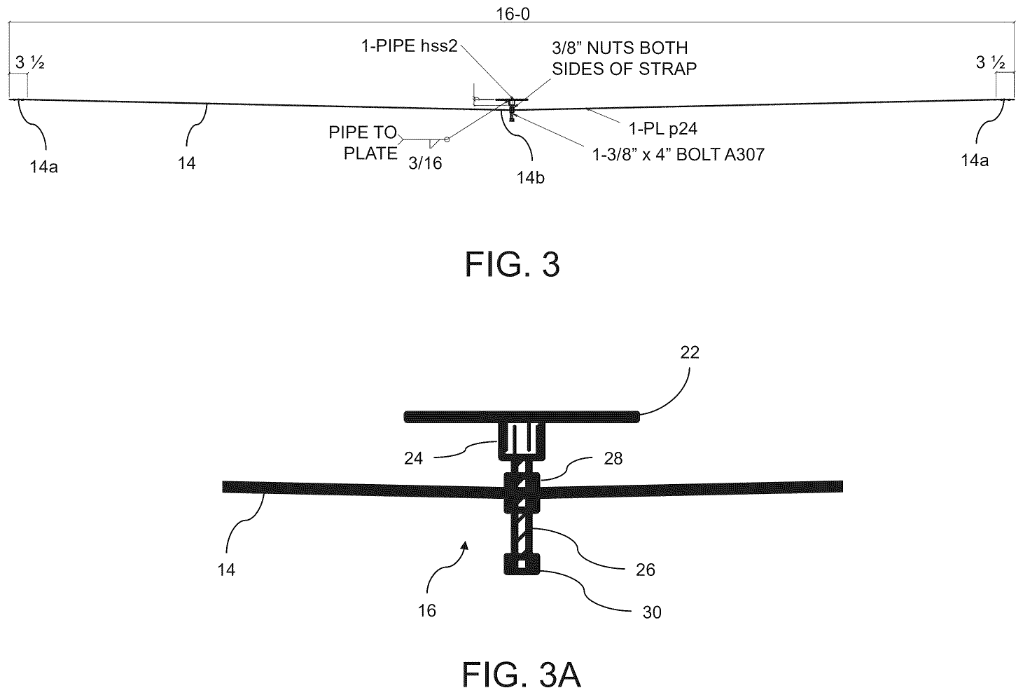

For example, when the door panel 12 is experiencing thermal bowing so that the interior side of the door panel 12 is convex (i.e., curved or bowed or warped inward), the strap 14 may flex toward a convex shape corresponding to the door panel 12. That is, the strap 14 is concave relative to the side of the door panel 12 (e.g., FIG. 3). Thus, the strap 14 may apply a biasing force along the threaded shaft 26 in a direction toward the door panel 12 to urge the strap 14 and the door panel 12 toward a less convex or flattened shape. By adjusting the nuts 28 along the threaded shaft 26 to move the strap 14 further from the door panel 12 (i.e., to a more convex shape), the biasing force may be increased due to the strap being biased toward its flattened shape. By adjusting the nuts 28 along the threaded shaft to move the strap 14 closer to the door panel 12 (i.e., to a more flattened shape), the biasing force may be decreased.

Similarly, when the door panel 12 is experiencing thermal bowing so that the interior side of the door panel is concave (i.e., curved or bowed or warped outward), the strap 14 may flex toward a concave shape corresponding to the door panel 12. That is, the strap 14 is convex relative to the side of the door panel 12. Thus, the strap 14 may apply a biasing force along the threaded shaft 26 in a direction away from the door panel 12 to urge the strap 14 and the door panel 12 toward a less concave or flattened shape. By adjusting the nuts 28 along the threaded shaft 26 to move the strap 14 toward the door panel 12 (i.e., to a more concave shape), the biasing force may be increased due to the strap being biased toward its flattened state. By adjusting the nuts 28 along the threaded shaft 26 to move the strap further from the door panel 12 (i.e., to a more flattened shape), the biasing force may be decreased.

Accordingly, the biasing force of the adjustment mechanism 16 may be adjusted based on the thermal bowing experienced by the door panel 12. For example, with the adjustment mechanism 16 installed on the interior side of the door panel 12, the adjustment mechanism 16 may be adjusted to apply biasing force toward the door panel 12 to resist or counteract or prevent thermal bowing of the door panel 12 toward the interior of the building (e.g., during the winter when the interior may be warmer than the external environment), and the adjustment mechanism may be adjusted to apply biasing force away from the door panel 12 to resist or counteract or prevent thermal bowing of the door panel 12 away from the building (e.g., during the summer when the external environment may be warmer than the interior of the building).

Optionally, the two nuts 28 may be disposed at the threaded shaft 26 and spaced from one another to allow for movement of the strap 14 between the nuts 28 as the strap 14 flexes between concave and convex shapes. For example, one nut 28 closest to the door panel 12 may positioned along the threaded shaft 26 such that the strap 14 engages the nut 28 and flexes to provide the biasing force as the door panel 12 begins bowing toward the interior of the building. This causes the strap 14 to flex more toward a concave shape relative to the interior side of the door panel 12, matching the flexing of the door panel 12, and thus causes the strap 14 to engage and flex against the nut 28 closest to the door panel 12, urging the strap 14 and the door panel 12 back toward a flattened shape. Similarly, one nut 28 furthest from the door panel 12 may be positioned along the threaded shaft 26 such that the strap 14 engages the nut 28 and flexes to provide the biasing force as the door panel 12 begins bowing away from the building. Here, the strap 14 flexes more toward a convex shape relative to the interior side of the door panel 12, matching the flexing of the door panel 12, and thus causes the strap to engage and flex against the nut 28 closest to the door panel 12. The nuts 28 may be spaced from one another along the threaded shaft 26 so that the strap 14 does not engage either nut 28 when the door panel 12 is in the flattened shape, thus relieving stress on the threaded shaft 26 and door panel 12. This also ensures that the door panel 12 remains in a flattened shape throughout temperature changes with little to no adjustment needed from a user.

Although the overhead door panel assembly is shown as having one door panel 12, it should be understood that the structural support system 10 is suitable for use with overhead door panel assemblies having a plurality of door panel sections connected to one another. For example, respective straps 14 may be mounted to each panel of the plurality of panels. Further, the structural support system may be mounted at any size door panel, such as single garage doors that may be between about 8 feet wide and 10 feet wide or double garage doors that may be between about 12 feet wide and 20 feet wide. Moreover, the system may include any suitable number of adjustment mechanisms spaced from one another horizontally across the door panel 12 and attached to the strap 14, such as to distribute the biasing force from the strap to respective regions of the door panel 12.

As shown in FIG. 1, the strap 14 may be sized so that, with the strap 14 extending horizontally along the door panel 12, the end regions 14a of the strap 14 are disposed at or near respective perimeter edge regions of the door panel 12. That is, a length of the strap 14 may generally correspond to a width of the door panel 12. Optionally, the edge regions 14a of the strap 14 may be disposed inboard of the perimeter edge regions of the door panel 12, such that the length of the strap 14 is less than the width of the door panel 12. The dimensions of the strap 14 (e.g., the length, width, gauge or thickness, and the like) may be adjusted based on the biasing force needed to flatten or resist bowing of the door panel 12.

Although described herein as biasing the door panel against thermal bowing, it should be understood that the structural support system 10 may be equipped at the overhead door panel assembly to resist or correct or reduce any bending or buckling of door panels. For example, the structural support system 10 may be equipped to reinforce an overhead door panel assembly or vertical wall structure (e.g., for security) or the structural support system 10 may be equipped to fix dents in the door panel of the overhead door panel assembly, where one or more adjustment mechanisms 16 may be attached to the door panel 12 at or near the dent to apply the biasing force at the dented portion of the door panel 12.

FIGS. 2 and 3 depict example dimensions of the structural support system 10. For example, the strap 14 may be about 16 feet long and have a width of about 1.25 inches. The strap 14 may comprise M11 steel strapping. The openings 18 at the respective end regions 14a of the strap 14 may have respective diameters of about 0.1875 inches, with a first opening positioned about 1 inch inboard of the outer edge of the strap 14 along the longitudinal axis of the strap 14 and a second opening positioned about 1.5 inches inboard of the first opening along the longitudinal axis of the strap 14. The central opening 20 of the strap 14 may have a diameter of about 0.4375 inches and the threaded shaft 26 extending through the central opening 20 may comprise an A307 bolt having a length of about 4 inches and a diameter of about 0.375 inches. The nuts 28 disposed along the threaded shaft 26 may have internal diameters of about 0.375 inches. The mounting plate 22 may be a square mounting plate having a length and width of about six inches. The receiver 24 may comprise an HSS2 pipe that extends from the mounting plate 22 a length of about 0.1875 inches. This maintains the central portion 14b of the strap 14 at a distance from the door panel 12 of at least 0.1875 inches.

Thus, with the structural support system 10 attached to the door panel 12, strapping may be installed flat on the door panel (e.g., attached at the two ends of the strap). The center mounting bracket 22 is attached to the door panel 12. The center mounting bracket 22 has the bolt or threaded shaft 26 that goes through the central hole 20 in the strapping 14 to apply pressure on the central region of the door panel 12. By threading the two nuts 28 along the threaded shaft 26, pressure may be applied against the door panel 12 to straighten the door panel 12. The system 10 is designed to straighten out the door panel 12 from side to side. Mounting brackets 22 may be installed at multiple locations on the door panels.

In some examples, the holders 28 may be movable along the shaft 26 between preset or predetermined positions. For example, the shaft 26 may include a plurality of through holes or notches formed along the shaft 26 and spaced from one another. The holders 28 may include a pin that is received into individual ones of the through holes or a tab that engages individual ones of the notches, such that the holders 28 are placed at the predetermined positions to adjust the biasing force provided by the strap 14.

Optionally, the overhead door panel assembly may include a sealing feature or biasing feature for urging the door panel into engagement with the sealing member around the perimeter of the opening in the building structure when the door panel is in the closed position. For example, the overhead door panel system may utilize characteristics of the overhead door panel systems described in U.S. Pat. No. 10,876,339 and/or U.S. Patent Pub. No. US-2022-0170304, which are hereby incorporated herein by reference in their entireties.

Changes and modifications in the specifically described examples can be carried out without departing from the principles of the present disclosure which is intended to be limited only by the scope of the appended claims, as interpreted according to the principles of patent law including the doctrine of equivalents.

1. A structural support system for an overhead door panel assembly, the structural support system comprising:
an adjustment mechanism comprising (i) a mounting structure configured to mount the structural support system at a side of a door panel of the overhead door panel assembly, (ii) a shaft extending from the mounting structure, (iii) an adjustable portion that is movable along the shaft and (iv) a flexible strap;
wherein the flexible strap comprises opposing end regions and a central region between the opposing end regions, and wherein, with the structural support system mounted at the side of the door panel of the overhead door panel assembly, (i) the opposing end regions of the flexible strap are attached at respective perimeter side regions of the door panel and (ii) the central region of the flexible strap extends along the side of the door panel between the perimeter side regions;
wherein, with the structural support system mounted at the side of the door panel of the overhead door panel assembly, (i) the mounting structure is disposed at the side of the door panel and between the central region of the flexible strap and the side of the door panel, (ii) the shaft extends from the mounting structure and through an aperture formed through the central region of the flexible strap and (iii) the adjustable portion engages the central region of the flexible strap near the aperture and is movable along the shaft to adjust spacing between the central region of the flexible strap and the side of the door panel; and
wherein, with the structural support system mounted at the side of the door panel of the overhead door panel assembly, and with the central region of the flexible strap spaced from the side of the door panel, the flexible strap applies a biasing force at the door panel in a direction parallel to a longitudinal axis of the shaft.

2. The structural support system of claim 1, wherein, with the structural support system mounted at the side of the door panel of the overhead door panel assembly, and with the flexible strap forming a convex shape relative to the side of the door panel, the biasing force is away from the side of the door panel.

3. The structural support system of claim 2, wherein, with the structural support system mounted at the side of the door panel of the overhead door panel assembly, and with the flexible strap forming the convex shape relative to the side of the door panel, the adjustable portion is movable along the shaft to decrease the spacing between the central region of the flexible strap and the side of the door panel and increase the biasing force away from the side of the door panel.

4. The structural support system of claim 1, wherein, with the structural support system mounted at the side of the door panel of the overhead door panel assembly, and with the flexible strap forming a concave shape relative to the side of the door panel, the biasing force is toward the side of the door panel.

5. The structural support system of claim 4, wherein, with the structural support system mounted at the side of the door panel of the overhead door panel assembly, and with the flexible strap forming the concave shape relative to the side of the door panel, the adjustable portion is movable along the shaft to increase the spacing between the central region of the flexible strap and the side of the door panel and increase the biasing force toward the side of the door panel.

6. The structural support system of claim 1, wherein the adjustment mechanism comprises a spacer disposed along the shaft between the adjustable portion and the mounting structure, and wherein the spacer maintains at least a threshold amount of space between the central region of the flexible strap and the side of the door panel.

7. The structural support system of claim 1, wherein the shaft comprises a threaded shaft, and wherein the adjustable portion comprises at least one threaded receiver that threadedly receives the threaded shaft.

8. The structural support system of claim 7, wherein the at least one threaded receiver comprises (i) a first threaded receiver disposed along the threaded shaft between the central region of the flexible strap and the mounting structure and (ii) a second threaded receiver disposed between the central region of the flexible strap and an end of the threaded shaft distal from the mounting structure.

9. The structural support system of claim 8, wherein, with the flexible strap engaging the first threaded receiver, the biasing force is toward the side of the door panel to counter flexing of the door panel toward the flexible strap.

10. The structural support system of claim 8, wherein, with the flexible strap engaging the second threaded receiver, the biasing force is away from the side of the door panel to counter flexing of the door panel away from the flexible strap.

11. The structural support system of claim 1, wherein the opposing end regions of the flexible strap engage the side of the door panel.

12. The structural support system of claim 1, wherein the side of the door panel comprises an interior side of the door panel.

13. The structural support system of claim 1, wherein the overhead door panel assembly comprises a plurality of door panels, and wherein a flexible strap and at least one adjustment mechanism are disposed at each door panel of the plurality of door panels.

14. The structural support system of claim 1, wherein the overhead door panel assembly comprises an overhead garage door panel assembly.

15. The structural support system of claim 1, wherein the flexible strap applies the biasing force at the door panel to urge the door panel toward a flattened shape.

16. A structural support system for an overhead door panel assembly, the structural support system comprising:
an adjustment mechanism comprising (i) a mounting structure configured to mount the structural support system at a side of a door panel of the overhead door panel assembly, (ii) a threaded shaft extending from the mounting structure, (iii) an adjustable portion that is movable along the threaded shaft and (iv) a flexible strap;
wherein the flexible strap comprises opposing end regions and a central region between the opposing end regions, and wherein, with the structural support system mounted at the side of the door panel of the overhead door panel assembly, (i) the opposing end regions of the flexible strap are attached at respective perimeter side regions of the door panel and (ii) the central region of the flexible strap extends along the side of the door panel between the perimeter side regions;
wherein, with the structural support system mounted at the side of the door panel of the overhead door panel assembly, (i) the mounting structure is disposed at the side of the door panel and between the central region of the flexible strap and the side of the door panel, (ii) the threaded shaft extends from the mounting structure and through an aperture formed through the central region of the flexible strap and (iii) the adjustable portion engages the central region of the flexible strap near the aperture and is movable along the threaded shaft to adjust spacing between the central region of the flexible strap and the side of the door panel;
wherein the adjustable portion comprises (i) a first threaded receiver disposed along the threaded shaft between the central region of the flexible strap and the mounting structure and (ii) a second threaded receiver disposed between the central region of the flexible strap and an end of the threaded shaft distal from the mounting structure;
wherein, with the structural support system mounted at the side of the door panel of the overhead door panel assembly, and with the central region of the flexible strap spaced from the side of the door panel, the flexible strap applies a biasing force at the door panel in a direction parallel to a longitudinal axis of the threaded shaft;
wherein, with the structural support system mounted at the side of the door panel of the overhead door panel assembly, and with the flexible strap forming a concave shape relative to the side of the door panel, the flexible strap engages the first threaded receiver and the biasing force is toward the side of the door panel; and
wherein, with the structural support system mounted at the side of the door panel of the overhead door panel assembly, and with the flexible strap forming a convex shape relative to the side of the door panel, the flexible strap engages the second threaded receiver and the biasing force is away from the side of the door panel.

17. The structural support system of claim 16, wherein, with the structural support system mounted at the side of the door panel of the overhead door panel assembly, and with the flexible strap forming the convex shape relative to the side of the door panel, the second threaded receiver is movable along the threaded shaft to decrease the spacing between the central region of the flexible strap and the side of the door panel and increase the biasing force away from the side of the door panel.

18. The structural support system of claim 16, wherein, with the structural support system mounted at the side of the door panel of the overhead door panel assembly, and with the flexible strap forming the concave shape relative to the side of the door panel, the first threaded receiver is movable along the threaded shaft to increase the spacing between the central region of the flexible strap and the side of the door panel and increase the biasing force toward the side of the door panel.

19. The structural support system of claim 16, wherein the adjustment mechanism comprises a spacer disposed along the threaded shaft between the adjustable portion and the mounting structure, and wherein the spacer maintains at least a threshold amount of space between the central region of the flexible strap and the side of the door panel.

20. The structural support system of claim 16, wherein the side of the door panel comprises an interior side of the door panel.
